(19) United States
(12) Patent Application Publication
(10) Pub. No.: US 2026/0320361 A1
(43) Pub. Date: Oct. 15, 2026

(54) GRADIENT-AWARE SINGULAR VALUE DECOMPOSITION FOR NEURAL NETWORK COMPRESSION

(71) Applicant: Hewlett Packard Enterprise Development LP, Spring, TX (US)

(72) Inventors: Lucas Henrique Morais, Barcelona (ES); Sergey Serebryakov, Milpitas, CA (US); Giacomo Pedretti, San Francisco, CA (US)

(21) Appl. No.: 19/175,212

(22) Filed: Apr. 10, 2025

(51) Int. Cl. G06N 3/0495; G06N 3/084

(52) U.S. Cl. CPC G06N 3/0495; G06N 3/084

(57) ABSTRACT

According to an implementation, a gradient-aware neural network compression technique reduces model size while maximizing output quality preservation. The method evaluates partial derivatives of a loss function with respect to pre-activations through backpropagation on calibration data without updating weights. A diagonal gradient matrix is generated based on these derivatives, and singular value decomposition is applied to a product of this gradient matrix, the weight matrix, and a scaling matrix derived from input activations. Truncated decomposition components are produced by removing columns and rows based on a truncation parameter that balances information loss against compression. Two smaller consecutive layers replace each original layer, with weights corresponding to component matrices derived from the truncated decomposition. In a variant implementation, a power factor approach partitions neurons from each layer among two groups, where the smaller group is responsible for most of the magnitude of the error term vector, creating a salience matrix.

### BACKGROUND

Neural network models have grown significantly in size and complexity in recent years, with large language models (LLMs) containing billions of parameters. These models demonstrate remarkable capabilities across various tasks, including natural language understanding, language generation, and image classification. The substantial size of these models can present deployment challenges, particularly for inference, as they require significant memory resources even on high-performance computing hardware such as datacenter-grade GPUs.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 is a block diagram of an implementation computer system;

FIG. 2 is a flowchart of an example Singular Value Decomposition (SVD) method;

FIG. 3 is a flowchart of an implementation method of a gradient-aware SVD technique for neural network compression;

FIG. 4 is a flowchart of an implementation method of a gradient-aware SVD technique for neural network compression;

FIG. 5 is a flowchart of an implementation method for gradient-aware compression of a neural network model; and

FIG. 6 is a flowchart of an implementation method for neural network compression using a power factor approach.

### DESCRIPTION

The following disclosure provides many different examples for implementing different features. Specific examples of components and arrangements are described below to simplify the present disclosure. These are, of course, merely examples and are not intended to be limiting.

The particular implementations are merely illustrative of specific configurations and do not limit the scope of the claimed implementations. Features from different implementations may be combined to form further examples unless noted otherwise. Various implementations are illustrated in the accompanying drawing figures, where identical components and elements are identified by the same reference number, and repetitive descriptions are omitted for brevity.

Variations or modifications described in one of the implementations may also apply to others. Further, various changes, substitutions, and alterations can be made herein without departing from the spirit and scope of this disclosure as defined by the appended claims.

While the inventive aspects are described primarily in the context of large language models (LLMs) and neural network compression for inference optimization, it should also be appreciated that these inventive aspects may also apply to other machine learning architectures and applications. In particular, aspects of this disclosure may similarly apply to computer vision models, multimodal systems, recommendation engines, and any deep learning architecture where weight matrices can benefit from gradient-aware compression techniques to reduce memory footprint while preserving model quality.

Large neural network models, particularly large language models (LLMs), have become increasingly powerful but face significant deployment challenges due to their enormous size. These models often contain billions of parameters, making them difficult to run efficiently, even on high-end hardware. When trying to deploy these models on devices with limited memory, such as mobile phones, edge servers, or consumer hardware, the problem can become even more severe. The large memory footprint leads to slow inference speed, high operational costs, and sometimes makes deployment impossible on certain devices.

The present disclosure addresses these challenges through an improved approach to neural network compression. Unlike traditional compression methods that focus on preserving the largest weight values or minimizing changes to layer outputs, the techniques described here use gradient information to identify which parts of the model are most significant for accuracy. This gradient-aware approach allows for more intelligent compression decisions by distributing information loss among weights in a way that minimizes impact on the model's output quality.

In implementations, the approach applies singular value decomposition (SVD) to a specially constructed product of matrices that incorporates gradient information, ensuring that the parts that contribute most to accuracy are preserved in response to model compression. At the same time, less significant components are simplified or removed. The result is a compressed model that maintains high accuracy while requiring significantly less memory and computational resources.

In various implementations, two variants of this gradient-aware compression technique are presented. The first variant uses precise gradient values calculated through backpropagation on sample data. The second variant employs a “power factor” approach to more coarsely classify neurons as either significant or non-significant based on that gradient information, providing better stability when compressing models at higher ratios. Both methods replace each original layer with smaller consecutive layers, reducing the total parameter count while preserving model quality.

The compressed models require less memory storage and exhibit faster inference times, enabling deployment on memory-constrained systems such as edge servers or mobile devices. The proposed approach achieves higher accuracy at similar compression levels—or higher compression at similar accuracy levels—than alternative approaches. Additionally, the compressed models retain much of their ability to learn and adapt, making fine-tuning easier and less brittle than other compression methods. These and additional details are further discussed below.

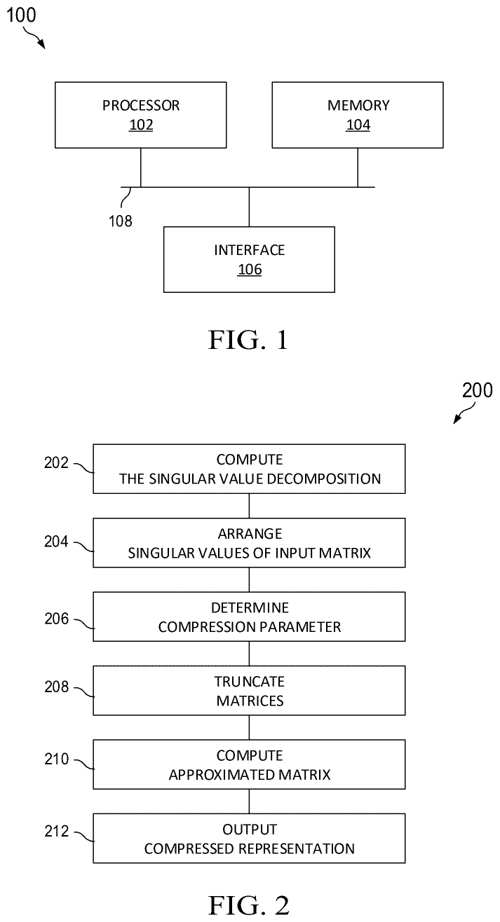

FIG. 1 illustrates a block diagram of an implementation computer system 100. The computer system 100 includes a processor 102, a memory 104, an interface 106, and a bus 108, which may (or may not) be arranged as shown. The processor 102 and memory 104 are coupled to the bus 108, which facilitates communication between the various components of the computer system 100. The interface 106 is also coupled to the bus 108 and provides connectivity for external communications.

Processor 102 may comprise various types of processing hardware circuitry capable of executing instructions for neural network compression operations. The processor 102 can be implemented as a Central Processing Unit (CPU), a Graphics Processing Unit (GPU), a Field-Programmable Gate Array (FPGA), an Application-Specific Integrated Circuit (ASIC), a Digital Signal Processor (DSP), a Tensor Processing Unit (TPU), or combinations thereof. In some implementations, the processor 102 may include specialized matrix multiplication circuits suited for the matrix operations involved in gradient-aware singular value decomposition techniques.

Memory 104 may include non-transitory or transitory memory components. Non-transitory memory can include Read-Only Memory (ROM), Flash memory, Electrically Erasable Programmable Read-Only Memory (EEPROM), hard disk drives, solid-state drives (SSD), optical discs, or other persistent storage media. Transitory memory can include Random Access Memory (RAM) such as Dynamic RAM (DRAM), Static RAM (SRAM), or other volatile memory types. Memory 104 may be organized in hierarchical structures, with faster cache memory coupled more directly to processor 102, and larger, slower main memory accessible via the bus 108. Memory 104 can store neural network models, calibration data, program instructions, and intermediate data for the compression process.

Different memory types serve various functions in the computer system 100. For example, cache memory can provide high-speed access to frequently used data and instructions. Main memory can offer larger storage capacity at somewhat lower speeds. Non-volatile memory retains data when power is removed, allowing the computer system to persistently store compressed neural network models.

Interface 106 may facilitate communication with external devices or networks, allowing the computer system 100 to receive neural network models for compression and to deploy compressed models for inference. Interface 106 can connect to various peripherals such as displays, input devices, or other computing systems where compressed neural networks may be utilized.

Bus 108 provides a communication pathway between processor 102, memory 104, and interface 106, enabling data transfer and coordination between these components during the compression and deployment processes. The bus 108 may comprise multiple signal lines for transferring data, addresses, and control signals.

Computer system 100 may include additional components not shown in FIG. 1, such as power management circuitry, cooling systems, specialized neural network accelerators, or additional processing units and memory. These components work together to support the computational demands of neural network operations, particularly the matrix manipulations for gradient-aware compression techniques that involve calculating partial derivatives, performing decompositions, and generating component matrices.

When not numerically defined, the “importance” or “significance” of a neuron conceptually refers to the sensitivity of overall model quality to perturbations to the weights of that neuron. The error term (the gradient of the loss with respect to the pre-activation of a neuron) is a typical numerical quantification of this notion. Still, the error term of a neuron is an exact estimator of loss degradation when changes to its pre-activation are infinitesimal, or in regions where that error term approximates a constant function. This motivates using the salience matrix described later, ensuring that neurons likely to retain high significance across a wide range of compression factors are preferentially preserved during compression. This avoids over-penalizing neurons that might not be the most significant at the start of the compression process, but which might become much more so after small perturbations.

FIG. 2 illustrates a flowchart of an example Singular Value Decomposition (SVD) method 200 for data compression. Singular Value Decomposition (SVD) is a low-rank approximation technique for dimensionality reduction and data compression. SVD decomposes a matrix into three component matrices, allowing for low-rank approximation by retaining the largest singular values and their corresponding singular vectors. This approach can be particularly advantageous for compressing neural network weight matrices, where many parameters may contribute minimally to model performance.

At step 202, computation of the singular value decomposition occurs for a given input matrix A with dimensions n×m. Matrix A represents the original data matrix to be compressed, which in the context of neural network compression can be a weight matrix from a particular layer. For example, matrix A can contain the connection weights between neurons in adjacent layers in a fully connected layer. This weight matrix often contains redundant information and can be approximated with fewer parameters without significantly affecting network performance.

The SVD process decomposes matrix A into a product of three matrices: A (UΣ)V^{T}. Here, the matrix U is an n×k matrix containing the k most significant eigenvectors of AA^{T}. They are most significant in the sense that the preservation of these particular k vectors among any k-element subset of the eigenvectors of AA^{T} leads to the minimum compression loss as measured by the Frobenius norm of the difference between the original matrix and the one reconstructed from the compressed SVD outputs, as a consequence of Eckart-Young theorem on SVD behavior.

The orthonormal vectors form the left singular vectors of the matrix A and represent the principal directions in the column space (or range) of the matrix A. The matrix sigma Σ is a k×k diagonal matrix containing the k singular values of the matrix A, ordered from the largest to smallest from left to right. The matrix V is an m×k matrix containing the k most significant eigenvectors of A^{T}A. The parameter k is an arbitrary positive integer that determines the compression strength, with the constraint that k<min(m,n). A smaller k value results in higher compression but potentially more information loss.

This decomposition provides a way to represent the original matrix A as a sum of k rank-one matrices, each weighted by its corresponding singular value. The largest singular values and their corresponding singular vectors capture the most significant patterns in the data as described before.

At step 204, the singular values of matrix A are arranged in descending order to form the diagonal Sigma matrix Σ with dimensions k×k. These singular values correspond to the square roots of the eigenvalues from the previous calculations and represent the scaling factors along each principal direction. The ordering from largest to smallest places the significant components first, allowing for effective truncation in subsequent steps.

Each singular value quantifies the variation captured along its corresponding singular vector direction. The lower a singular value is, the lower will be the impact on information loss of removing it. In SVD-based compression, matrices where the cumulative distribution of squared singular values is highly concentrated, with a small number of singular values amounting to a large fraction of total singular value squares, are highly compressible with minimal information loss.

At step 206, the compression parameter k is determined based on desired compression strength or quality preservation requirements. This parameter represents the rank of the approximated matrix and directly controls the trade-off between compression ratio and information preservation. The parameter k can be selected through various strategies, such as retaining a percentage of the total sum of squared singular values (setting a threshold for acceptable information loss) or meeting specific memory constraints. Reducing the k value is equivalent to setting elements from the singular values matrix Σ to zero.

The loss of information resulting from zeroing the singular values is quantifiable as the sum of squares of the discarded singular values {σₜ_{₁}, . . . , σₜ_{_{d}}}

$${‖ W - {W}_{COMPRESSED} ‖}_{F}^{2} = {\sum }_{t = 1}^{d} {σ}_{{i}_{t}}^{2} ,$$

which represents the squared Frobenius norm of the difference between the original weight matrix W and its compressed approximation W_{COMPRESSED}. Accordingly, the loss equals the sum of squares of the discarded singular values (σᵢ_{ₜ}), where t ranges from 1 to d, with d representing the number of singular values zeroed out during compression.

This mathematical relationship, derived from the Eckart-Young theorem, provides a precise measure of how much information is lost when reducing the rank of a matrix through SVD. Smaller singular values contribute less to this sum, which explains why removing them results in minimal information loss. This equation serves as a theoretical foundation for determining optimal truncation parameters and evaluating compression quality.

At step 208, truncation of the matrices occurs by removing all but their most significant components. This step removes all but the first k columns of the left singular vector matrix U, all but the first k rows and columns from the Sigma matrix ΣX, and all but the first k rows from the transposed right singular vector matrix V^{T}. This process is numerically equivalent to the zeroing of all but the first k singular values in Σ, but with the advantage of reducing the total number of parameters in the matrices. The truncation eliminates the dimensions associated with smaller singular values, which typically represent noise or less significant features in the data. This dimensional reduction is the mechanism through which SVD achieves compression.

At step 210, the approximated matrix is computed by multiplying the truncated components: A≈(UΣ)V^{T}. This multiplication reconstructs an approximation of the original matrix using k rank-one matrices, each weighted by its corresponding singular value. The result is a compressed representation that maintains the significant patterns and relationships from the original data with substantially less storage space. The quality of this approximation can be mathematically guaranteed through the Eckart-Young theorem.

According to the Eckart-Young theorem, no other method exists to produce a rank-k approximation of any matrix with less information loss as measured by changes to its Frobenius norm than SVD. This mathematical guarantee ensures that SVD provides the optimal low-rank approximation when measured by the Frobenius norm difference between the original and compressed matrices.

At step 212, the compressed representation is output to the neural network. This representation consists of two matrices, UΣ and V^{T} which necessitate storing (n×k)+(m×k) values instead of the original n×m values. This can result in significant memory savings for large matrices where k is much smaller than both n and m. When used in a neural network, the original layer with a weight matrix A is replaced by two consecutive layers with weight matrices corresponding to UΣ and V^{T}, respectively.

While SVD provides the mathematically optimal compression in terms of the Frobenius norm, it should be appreciated that other information metrics might be more significant to model quality. Specifically, SVD is more likely to preserve weight values that are large in magnitude, which is not optimal if the target is to minimize overall model degradation as measured by loss metrics such as perplexity.

The fact that minimizing changes to weight elements does not necessarily leads to minimum changes to loss metrics can be noted by analyzing the partial derivative of the loss to a weight element, s_{i,j}. It obeys the expression

$${s}_{i , j} = \frac{dL}{{dW}_{i , j}^{( l )}} = {δ}_{i}^{( l )} {A}_{j}^{( l - 1 )} ,$$

where s_{i,j} represents the sensitivity of the loss L to changes in weight element W_{i,j} at layer l,

$${δ}_{i}^{( l )}$$

is the error term for neuron i in layer l, and

$${A}_{j}^{( l - 1 )}$$

is the activation from neuron j in the previous layer (l−1).

The error term δ^{(l)} is defined as:

$${δ}^{( l )} = \frac{dL}{{dZ}^{( l )}} = ( {( {W}^{( l + 1 )} )}^{T} {δ}^{( l + 1 )} ) \cdot {f}^{{( l )}^{′}} ( {Z}^{( l )} ) ,$$

where Z^{(l)} represents the pre-activations of layer l, W^{(l+1)} is the weight matrix of the subsequent layer, δ^{(l+1)} is the error term of the subsequent layer, f^{(l)′} is the derivative of the activation function at layer l, and · denotes the Hadamard (element-wise) product.

Widely used activation functions such as ReLU, GELU, ELU, Swish, Sigmoid, Softplus, and Tanh are all such that

$${lim}_{x \to - ∞} {f}^{r ( x )} = 0 .$$

Consequently, when

$${Z}_{j}^{( l )} << 0 , {f}^{{( l )}^{′}} ( {Z}_{j}^{( l )} )$$

is approximately zero, and s_{i,j} becomes insensitive to the magnitude |W_{i,j}|. Similar behavior happens when

$${Z}_{j}^{( l )} >> 0$$

for Sigmoid and Tanh, since

$${lim}_{x \to + ∞} {f}^{′ ( x )} = 0$$

for these functions. In all these cases, the tendency of SVD to preferentially preserve high-magnitude weights is not optimal and might be counter-productive.

However, the partial derivative s_{i,j} is proportional to

$${A}_{j}^{( l - 1 )} ,$$

the activation from the previous layer. Activation-aware SVD (ASVD) leverages this insight by modifying standard SVD to account for activation magnitudes. It multiplies weights W_{i,j} by

$$𝔼 [ {A}_{j}^{( l - 1 )} ] ,$$

the expected value of activations for input j, where this mean value is obtained from calibration data. This scaling ensures that weight values multiplied by large activation values are better preserved during compression since they have a greater impact on overall model quality.

By incorporating activation information into the compression process, ASVD achieves better preservation of model quality at the same compression ratio compared to standard SVD.

While standard SVD provides mathematically optimal compression in terms of the Frobenius norm, and ASVD enhances this by considering activation magnitudes, further improvements can be achieved by Truncation-aware SVD (SVD-LLM), which aims at restricting model degradation by minimizing changes to neuron outputs (also called pre-activations) rather than neuron weights.

As discussed previously, given a certain target rank k, the original SVD method minimizes the following measure of information loss:

$${‖ W - {W}_{COMPRESSED} ‖}_{F}^{2} = {\sum }_{t = 1}^{d} {σ}_{{i}_{t}}^{2} ,$$

where the left side of the equation is the squared Frobenius norm of the difference between the original weight matrix W and its compressed approximation W_{COMPRESSED}, and its right side is the sum of squares of the discarded singular values.

SVD-LLM, on the other hand, aims to minimize changes to the pre-activations of each layer:

$${‖ Δ Z ‖}_{F}^{2} = {‖ W - {W}_{COMPRESSED} ‖}_{F}^{2} = {\sum }_{t = 1}^{d} {σ}_{{i}_{t}}^{2} ,$$

where ΔZ represents the change in pre-activations and X represents the input activations to the layer. The equation measures how compression affects the actual outputs of the layer rather than just the weight matrix itself. It also works for any batch size, allowing X to be either a vector or matrix of activations feeding the layer being compressed.

This can be achieved by feeding SVD with WS rather than W, where S is the lower-triangular result of the Cholesky decomposition of a Gram matrix XX^{T}, where X is the calibration input. This transformation ensures that the SVD process directly minimizes changes to layer outputs rather than weight values.

The matrix XX^{T} is a Gram matrix, which is a mathematical construct widely used in linear algebra and machine learning. A Gram matrix is formed by multiplying a matrix by its own transpose, resulting in a symmetric positive semi-definite matrix. In the context of neural networks, when X represents the matrix of input activations to a layer, the corresponding Gram matrix XX^{T} captures the correlations between different input features.

Each element (i,j) in the Gram matrix represents the dot product between the i-th and j-th input feature vectors across the calibration data. The Gram matrix provides valuable information about the structure of the input space and can be decomposed using methods like Cholesky decomposition to facilitate efficient compression techniques. The positive semi-definite nature of the Gram matrix ensures that it can be factorized as (XX^{T}+ϵ₁I)=LL^{T}, where L is a lower-triangular matrix that serves as the scaling matrix in the compression process, and ϵ₁ is an infinitesimal positive value that ensures the positive-definiteness of the factorization input.

The two component matrices are then defined as C₁=UΣ and C₂=V^{T}S¹, where WS=UΣV^{T} (from the SVD of WS). Together, these two matrices form a factorized representation of the original weight matrix that minimizes changes to the layer's functional behavior.

It should be appreciated that ASVD does not generally minimize this information loss metric, despite ASVD's improvements over standard SVD, highlighting the importance of carefully selecting the appropriate compression objective based on what aspects of model performance need to be preserved.

SVD-LLM has demonstrated substantial advantages over ASVD, illustrating that directly minimizing changes to layer outputs can be more effective than focusing on either weight magnitudes (standard SVD) or activation-weighted weights (ASVD).

The progression from SVD to ASVD to SVD-LLM represents an evolution in compression techniques, with each method addressing the limitations of its predecessors by incorporating more information about how neural networks function during inference.

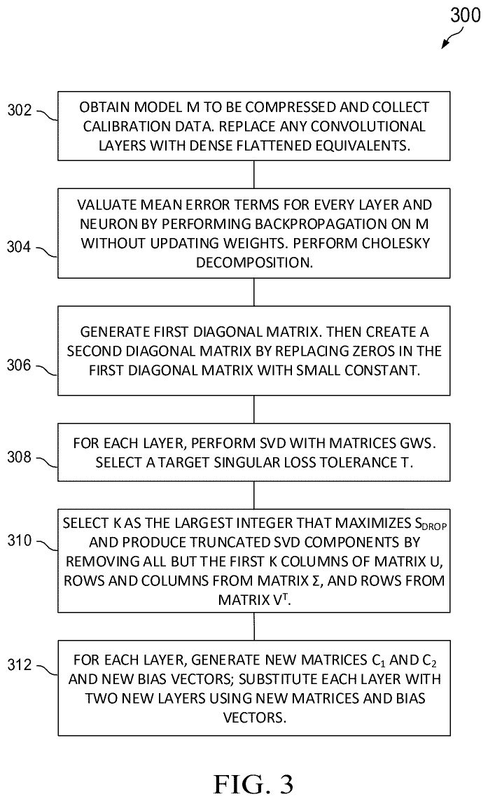

FIG. 3 illustrates a flowchart of an implementation method 300 of a gradient-aware SVD technique for neural network compression. While the Truncation-aware SVD minimizes changes to layer pre-activations, the gradient-aware SVD technique aims to minimize changes to the overall model loss L, representing a shift in approach, focusing directly on preserving model performance rather than intermediate representations. In various implementations, the method may include additional or fewer steps, or the steps may be performed differently than illustrated.

Gradient-aware SVD of method 300 minimizes the Frobenius norm

$${‖ Δ L ‖}_{F}^{2} ,$$

where

$${‖ Δ L ‖}_{F}^{2} = {‖ G Δ Z ‖}_{F}^{2} = {‖ G ( W - {W}_{C OMPRESSED} ) X ‖}_{F}^{2} = {\sum }_{t = 1}^{d} {σ}_{{i}_{t}}^{2} ,$$

where L is the overall model loss and G is the diagonal gradient matrix.

More generally, one can note that

$$\frac{dL}{{dZ}_{i}}$$

can be much smaller for some neurons than others. This variation in gradient magnitudes across neurons indicates that some neurons are more significant for model performance than others.

As an illustration of this fact, one might observe that changes to negative values serving as input to the ReLU activation function do not change its output if the new input is still negative. As a result, changes to neuron weights caused by compression that only perturb negative pre-activations in a way that keep them negative do not bear any consequence on model output. That is, these perturbations to particular Zᵢ values do not modify L because they occur in a region where

$$\frac{dL}{{dZ}_{i}} = 0 .$$

This creates an opportunity for a compression procedure, as proposed, to preserve model quality by concentrating compression loss in the neurons related to the lowest-magnitude gradients. By strategically allocating compression noise to neurons that minimally impact the loss function, method 300 can achieve higher compression ratios while maintaining model quality.

At step 302, the method begins with obtaining a model M to be compressed and collecting calibration data. The model M typically contains multiple layers with weight matrices that need compression. The calibration data consists of model inputs X_{M} and corresponding reference model output labels Y_{M} obtained from random sampling of training data or from a diverse selection of typical production-environment inputs. By performing a single forward pass of M over every element in X_{M}, a different calibration matrix X is obtained for every layer i of the model, corresponding to the activations of the previous layer caused by inference over X_{M}, if i>0; or X_{M} itself, in the case of the first layer of the model (for which i is zero).

The layer-specific X matrices are calculated only once throughout the whole compression process, before any compression has occurred, avoiding recomputation during the compression of each specific layer.

The reference model output labels Y_{M} are used for evaluating partial derivatives of model loss with respect to weight elements, whenever that is required by a compression step.

If any convolutional layers exist in the neural network, they are replaced with their dense flattened equivalents. This transformation is used because SVD-based compression methods are primarily designed to work with dense weight matrices rather than the specialized structures of convolutional layers.

Accordingly, the conversion process can involve transforming each convolutional layer into a mathematically equivalent dense (fully connected) layer representation. For example, this can be accomplished using PyTorch's Unfold operation, which extracts sliding local blocks from an input tensor and reshapes them into a matrix format. This unfolding operation converts the convolution operation into a matrix multiplication between the unfolded input and a reshaped filter matrix. The resulting dense representation preserves the same functionality as the original convolutional layer but expresses it in a form that can be compressed with matrix-oriented methods.

At step 304, mean error terms are evaluated by calculating partial derivatives of the loss function with respect to pre-activations of each layer. This can be accomplished by performing backpropagation on the neural network model M using the calibration data without updating weights. For every layer i and every neuron j of layer i, the error term

$${δ}_{j}^{( i )} = \frac{dL}{{dZ}_{i , j}}$$

is calculated, representing the sensitivity of the model's loss function to changes in each neuron's pre-activation value.

Simultaneously, Cholesky decomposition is performed on an input XX^{T}, where X is the matrix of input activations to the layer being compressed, leading to the equivalence XX^{T}=SS^{T}, where S is a lower-triangular matrix that shall later be used as scaling matrix in the compression process.

Cholesky decomposition requires its input matrix to be positive-definite. Since XX^{T} is only guaranteed to be positive semi-definite, it suffices to add any small positive multiple of the identity matrix to XX^{T}, prior to its Cholesky processing, to ensure its positive definiteness. The scalar ϵ₁ multiplying the identity matrix is typically in the range between 10⁻¹⁰ to 10⁻⁵. Higher values achieve higher numerical stability at the cost of losing sensitivity to the original X.

More precise numerical methods for Cholesky evaluation allow for lower ϵ₁ values. Furthermore, it frequently leads to better results to perform Cholesky at higher precision (e.g., 64-bit) and then downscale its outputs to the precision of the model (e.g., BF16), than to perform the whole process at target model precision (BF16, in this example).

At step 306, a first diagonal gradient matrix G* is generated using the error terms obtained in the previous step. For each layer i, the diagonal elements of G* are the partial derivatives of the loss function with respect to each pre-activation of that layer. That is

$${G}^{*} = diag ( {δ}_{1}^{( i )} , … , {δ}_{{n}_{l}^{( i )}}^{( i )} ) ,$$

where

$${n}_{l}^{( i )}$$

is the number of neurons in the layer i.

$$G ≡ [ \begin{matrix}{δ}_{1} & … & 0 \\ ⋮ & ⋱ & ⋮ \\ 0 & … & {δ}_{n}\end{matrix} ] ≡ [ \begin{matrix}\frac{dL}{{dZ}_{1}} & … & 0 \\ ⋮ & ⋱ & ⋮ \\ 0 & … & \frac{dL}{{dZ}_{1}}\end{matrix} ]$$

Then, a second diagonal gradient matrix G is generated by replacing every 0 in the diagonal of the gradient matrix G* with a small constant ϵ₂ (e.g., between 10⁻¹⁰ to 10⁻⁵). This step ensures the gradient matrix is invertible for the subsequent matrix operations, ensuring numerical stability during computation. This is particularly advantageous for layers using ReLU as an activation function, since it produces a zero derivative (and thus a null error term) for all inputs lower than zero. Conversely, layers using smooth activation functions such as Swish might be much less influenced by this step, since they make error terms numerically equal to zero very infrequently, thus leading to few, if any, substitutions with ϵ₂.

Furthermore, batch-sizes higher than 1 tend to reduce the number of null error term elements even for layers using ReLU, since they make the error term used to compose G* an average of error terms evaluated from multiple samples, making zero values more unlikely.

The value ε₂, as well as any compression hyperparameter, can be selected based on grid-search or any other standard method for hyperparameter optimization. Still, any value within the suggested range should be adequate.

At step 308, singular value decomposition (SVD) is applied to the product of the gradient matrix G, weight matrix Wₗ of layer i, and scaling matrix S. This results in the factorization GWᵢS=UΣV^{T}, where U contains the left singular vectors, X is a diagonal matrix of singular values in descending order, and V^{T} contains the right singular vectors.

Concurrently, a target singular loss tolerance T∈[0,1] is selected to guide the compression process, determining how much information loss is acceptable.

At step 310, a truncation parameter k is determined and the SVD components are truncated accordingly. The parameter k can be selected as the largest integer in

$$[ 1 , {n}_{l}^{( i )} - 1 ]$$

that maximizes the sum of squared singular values

$${S}_{drop} ( k ) = {\sum }_{j = k}^{{n}_{l}^{( i )}} {σ}_{i , j}^{2} .$$

This sum represents the total squared magnitude of the singular values that will be dropped during truncation.

The selection of k is subject to the constraint that

$${S}_{drop} ( k ) \leq T \times {\sum }_{j = 1}^{{n}_{l}^{( i )}} {σ}_{i , j}^{2} ,$$

where T is the target singular loss tolerance in [0,1]. This constraint ensures that the information loss due to truncation does not exceed a fraction T of the total information contained in all singular values.

In general, the singular value distributions of distinct layers differ in their concentration. Consequently, when an identical T value is used to guide the selection of k for each of the model's layers as described above, different layers are likely to be subject to different compression ratios, in a way that is sensitive to the inherent compressibility of each layer. The most compressed layers will then be those with the most concentrated singular value distributions.

Once k is determined, truncated SVD matrix components U_{T}, Σ_{T}, and

$${V}_{t}^{T}$$

are produced by removing all but the first k columns of the matrix U, all but the first k rows and columns from Σ, and all but the first k rows from V^{T}. This results in a factorization

$${GW}_{i}^{′} S = {U}_{T} {\sum }_{T} {V}_{t}^{T} ,$$

where

$${W}_{i}^{′}$$

is the weight matrix of layer i after compression.

Removing the singular values σₖ, . . . , σₙ from the sigma equation X to produce the truncated sigma equation Σ_{T} leads to

$${‖ Δ L ‖}_{F}^{2} = {σ}_{k}^{2} + … + {σ}_{n}^{2} ,$$

where n is the number of singular values in the sigma equation Σ.

The change to the pre-activations caused by compression can be characterized as ΔZ=ΔWX. Assuming a constant diagonal gradient matrix G, the change to the loss function value resulting from the change to the pre-activations is: ΔL=GΔZ=G(W′X−WX).

Assuming

$$ω = {σ}_{k}^{2} + … + {σ}_{n}^{2} and r = rank ( {GW}^{′} S ) ,$$

applying the Eckart-Young theorem to GWS=UΣV^{T}, we find that

$$ω = {‖ {GW}^{′} S - GWS ‖}_{F}^{2} = {‖ G Δ WS ‖}_{F}^{2} .$$

As

$$trace ( {AA}^{T} ) = {‖ A ‖}_{F}^{2}$$

for any matrix

$$A , ω = trace ( G Δ {WS ( G Δ WS )}^{T} ) = trace ( G Δ {WSS}^{T} Δ {W}^{T} {G}^{T} ) = trace ( G Δ {WXX}^{T} Δ {W}^{T} {G}^{T} ) = trace ( G Δ {WX ( G Δ WX )}^{T} ) = {‖ G Δ WX ‖}_{F}^{2} = {‖ G Δ Z ‖}_{F}^{2} = {‖ Δ L ‖}_{F}^{2} .$$

This results in the model loss variation ∥ΔL∥_{F} to be minimum across any approximation of GWᵢS with the same rank as

$${GW}_{i}^{′} S .$$

Further, by the same Eckart-Young theorem, there is no rank-r approximation P of GWS such that ∥P−GWS∥_{F}<∥GW'S−GWS∥_{F}=∥Δ_{I}∥_{F}. If ΔL′=P−GWS, then there is no P with rank(P)=r such that ∥ΔL′∥_{F}<∥Δ_{L}∥_{F}. This ensures the optimality, with respect to ∥Δ_{L}∥_{F}, of the compressed matrix W′ resulting from the multiplication of the truncated components from step 310.

At step 312, two component matrices are generated from the SVD outputs with the goal of populating the weights of two new model layers, which together substitute the original layer being compressed.

A first component matrix C₁ is created by multiplying the inverse of the second diagonal gradient matrix G⁻¹ by the truncated U_{T} and truncated Σ_{T}:C₁=G⁻¹U_{T}Σ_{T}.

A second component matrix C₂ is created by multiplying the truncated

$${V}_{T}^{T}$$

by the inverse of the scaling matrix

$${S}^{- 1} : {C}_{2} = {V}_{T}^{T} {S}^{- 1} .$$

The use of the inverse of the scaling matrix S⁻¹ justifies the use of the Cholesky decomposition at step 304. If the matrix product GWᵢX was used as an input to the SVD instead of GWᵢS and the calibration input X was not invertible (as a result of, for instance, not being square), it would not be possible to build the second component matrix C₂, as implemented herein.

Additionally, for each layer i, new bias vectors are generated where b₁=bᵢ, where bᵢ is the original layer's bias vector and b₂=0 (a zero vector).

The original layer with weight matrix Wᵢ and bias vector bᵢ is then substituted with two consecutive layers using the first component matrix C₁ and the second component matrix C₂ and bias vectors b₁ and b₂ respectively. This substitution reduces the total parameter count while preserving the model's functional characteristics, particularly in directions that most significantly impact the loss function. The new layer combination thus approximates the original layer behavior as follows: A⁽ⁱ⁾=f⁽ⁱ⁾(WᵢA⁽ⁱ⁻¹⁾+bᵢ)≈f⁽ⁱ⁾(C₁(C₂A⁽ⁱ⁻¹⁾)+b₁).

Advantageously, the proposed gradient SVD approach directly addresses the limitation of previous methods by recognizing that some neurons contribute much more to model performance than others, as indicated by their gradient magnitudes. By concentrating compression loss in neurons with the lowest-magnitude gradients, the method preserves model quality more effectively than approaches that don't consider the varying importance of different neurons to overall performance.

To illustrate the effectiveness of the gradient-aware SVD approach, consider a simple example with a ReLU activation function processing two pre-activation values. In an uncompressed network, pre-activation values Z₁=−3.00 and Z₂=+3.00 produce post-activation outputs A₁=0.00 and A₂=+3.00 after passing through the ReLU function. This represents a baseline with zero change in pre-activation values

$$( {‖ Δ Z ‖}_{F}^{2} = 0 )$$

and gradient-weighted pre-activation values

$$( {‖ G Δ Z ‖}_{F}^{2} = 0 ) .$$

When compressed using the SVD-LLM approach, the pre-activation values might shift to Z₁=−3.28 and Z₂=+3.28, resulting in post-activation values A₁=0.00 and A₂=+3.28. This compression introduces a measurable change in the pre-activation Frobenius norm

$$( {‖ Δ Z ‖}_{F}^{2} = 0.16 )$$

and creates a non-zero change in the gradient-weighted pre-activation values

$$( {‖ G Δ Z ‖}_{F}^{2} = ( {δ}_{1} + {δ}_{2} ) \times 0.08 ,$$

indicating some impact on the model's loss function.

In contrast, the gradient-aware SVD method will preferentially concentrate compression loss among the weights of low-gradient neurons. It might modify the pre-activation values to Z₁=−3.40 and Z₂=+3.00, producing post-activation values A₁=0.00 and A₂=+3.00. While the same overall change to pre-activation values

$$( ( {‖ Δ Z ‖}_{F}^{2} = 0.16 )$$

is achieved, it maintains zero change in the gradient-weighted pre-activation values

$$( {‖ G Δ Z ‖}_{F}^{2} = 0 ) .$$

This occurs because the compression changes are concentrated in the direction with the lowest gradient impact—leveraging the fact that rendering a negative pre-activation value more negative does not affect the ReLU output.

This example demonstrates how gradient-aware SVD achieves compression while preserving model performance by allocating information loss to directions that minimally affect the loss function, recognizing that some neurons and activation patterns contribute more significantly to model performance than others.

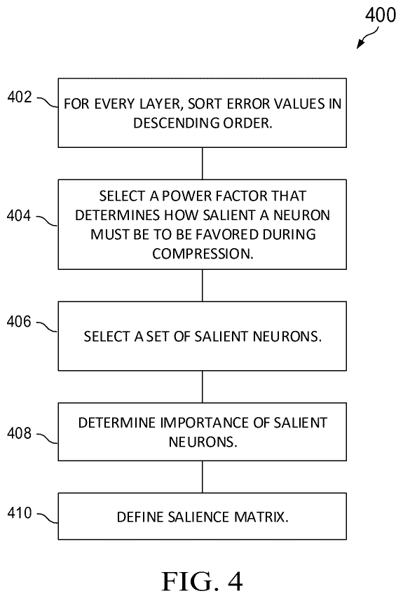

FIG. 4 illustrates a flowchart of an implementation method 400 of a gradient-aware SVD technique for neural network compression. This variant builds upon the approach shown in FIG. 3 but introduces a power factor mechanism to more robustly identify salient neurons. In various implementations, the method may include additional or fewer steps, or the steps may be performed differently than illustrated.

The second variant addresses a potential limitation of the first variant (method 300). The first variant minimizes the metric

$${‖ G Δ Z ‖}_{F}^{2} ,$$

which is the gradient-weighted change in pre-activations. The effectiveness of the first variant generally depends on the stability of the gradient values δ₁, . . . , δₙ during compression. If these values remain approximately constant throughout the compression process, then the change in loss (ΔL) accurately represents the overall change in model loss, and the compression is optimal.

However, if the gradient values change significantly during compression such that their rank order is modified, it is possible that the gradient matrix G will not optimally preserve the neurons that the loss function is most sensitive to. The second variant addresses this potential instability at high compression factors by using the salience matrix G_{P} instead of G, where G_{P} contains more coarse-grained information about which neurons the loss function is most sensitive to.

The second gradient-aware SVD technique begins with the same initial steps as method 300, obtaining a model to be compressed and collecting calibration data (step 302), followed by evaluating mean error terms through backpropagation and performing Cholesky decomposition (step 304). However, instead of proceeding to step 306 to generate diagonal gradient matrices, method 400 diverges to step 402, introducing an alternative approach for handling gradient information.

At step 402, for every layer i, the method sorts the error terms 6 in descending order, producing a sequence

$${δ}_{{t}_{1}}^{( i )} , … , {δ}_{{t}_{N}}^{( i )} ,$$

where N represents the number of neurons in layer i. This sorting identifies which neurons contribute most significantly to model performance based on their gradient magnitudes.

At step 404, a power factor P greater than 1 is selected, typically not lower than 3. This power factor determines how salient a neuron must be to receive preferential treatment during compression. Higher power factors create a more selective threshold, focusing preservation efforts on fewer, more significant neurons.

At step 406, for every layer i, the method evaluates the maximum integer qᵢ for which the following inequality holds:

$${\sum }_{r = 1}^{{q}_{i}} {δ}_{{t}_{r}}^{( i )} > P \times \frac{{q}_{i}}{N} \times {\sum }_{r = 1}^{N} {δ}_{{t}_{r}}^{( i )} .$$

This inequality identifies the subset of neurons whose cumulative gradient magnitude exceeds what would be expected if gradients were uniformly distributed, scaled by the power factor P. The method then defines the set Qᵢ={t₁, . . . , t_{q}_{ᵢ}} containing the indices of these salient neurons.

Another strategy for selecting the set of salient neurons relies in using

$${δ}_{j}^{( i )} 𝔼 [ {A}_{j}^{( i - 1 )} ]$$

instead of

$${δ}_{j}^{( i )}$$

as the base salience criterion for a neuron j of layer i, leading to a similar inequality involving the power factor P and still producing a set of salient neurons Qᵢ as above.

A second alternative strategy for obtaining salient neurons is to select all neurons l such that the

$$\vert {δ}_{l}^{( i )} \vert$$

scalar is more than m standard deviations higher than the mean of the sequence of elements in the |δ⁽ⁱ⁾| vector.

At step 408, for each layer i, the method creates a sequence

$${γ}_{1}^{( i )} , … , {γ}_{N}^{( i )} ,$$

where

$${γ}_{h}^{( i )} = M$$

if the neuron is salient (that is,

$$h ∈ {Q}_{i} ) or {γ}_{h}^{( i )} = 1$$

otherwise. The parameter M is set to a value greater than 1 and typically set to 2, effectively multiplying the importance of salient neurons while maintaining the baseline importance of non-salient neurons.

At step 410, for each layer i, the method defines a salience matrix

$${G}_{P}^{( i )} = diag ( {γ}_{1}^{( i )} , … , {γ}_{N}^{( i )} ) .$$

This diagonal matrix encodes the relative importance of each neuron based on the power factor analysis, creating a more stable gradient representation than the direct gradient values used in method 300. It should be appreciated that

$${G}_{P}^{( i )}$$

uses the original, unsorted neuron indexing, preserving the correspondence between salience values and their respective neurons in the network.

The method then continues with steps 308 and 310, as in FIG. 3, performing SVD on the product of matrices and selecting an appropriate truncation parameter to produce the truncated SVD components.

At step 312, for each layer i, the method generates the new component matrices C₁ and C₂. The first component matrix C₁ is created by multiplying the inverse of the salience matrix

$${G}_{P}^{( i )}$$

by the truncated U_{T} and truncated

$${\sum }_{T} : {C}_{1} = {( {G}_{P}^{( i )} )}^{- 1} {U}_{T} {\sum }_{T} .$$

The second component matrix C₂ is created by multiplying the truncated V_{T}^{T} by the inverse of the scaling matrix

$${S}^{- 1} : {C}_{2} = {V}_{T}^{T} {S}^{- 1} ,$$

as in method 300.

Additionally, for each layer i, new bias vectors are generated where b₁=bᵢ, where bᵢ is the original layer's bias vector and b₂=0 (a zero vector).

The original layer with weight matrix Wₗ and bias vector bᵢ is then substituted with two consecutive layers using the first component matrix C₁ and the second component matrix C₂ and bias vectors b₁ and b₂ respectively. The new layer combination thus approximates the original layer behavior as follows: A⁽ⁱ⁾=f⁽ⁱ⁾(WᵢA⁽ⁱ⁻¹⁾+bᵢ)≈f⁽ⁱ⁾(C₁(C₂A⁽ⁱ⁻¹⁾)+b₁).

While the first variant uses precise gradient values directly, which can be optimal for modest compression ratios, it may become unstable under higher compression ratios where gradient values might change substantially. In contrast, the second variant employs a binary or discrete weighting scheme (typically doubling the importance of salient neurons), which provides better stability when compressing models more aggressively. The power factor approach also helps prevent overfitting to the calibration data by focusing on the relative importance of neurons rather than their absolute gradient values.

The first variant (method 300) may perform slightly better at lower compression ratios where precise gradient information can be fully leveraged. However, the second variant (method 400) generally demonstrates more consistent performance across different compression ratios and is particularly advantageous for higher compression scenarios where maintaining stability becomes more challenging. Additionally, the power factor approach offers more flexibility through its configurable parameters (P and M), allowing users to adjust the compression strategy based on specific model characteristics and deployment constraints.

Both variants of the gradient-aware SVD approach offer advantages over existing neural network compression techniques. By strategically preserving the most significant neurons based on gradient information, these methods achieve higher compression ratios while maintaining model quality, allowing neural networks to be mapped with substantially less memory. Large language models that previously necessitated multiple high-end GPUs can have their context windows and batch sizes increased, be deployed to more constrained GPU clusters, or target edge hardware after compression, dramatically expanding their potential applications and accessibility.

The compressed models based on the gradient-aware SVD approach demonstrate higher inference speed than their uncompressed counterparts. This performance improvement stems from the reduced parameter count and the smaller memory footprint. The reduced parameter count directly decreases the computations during forward passes. The smaller memory footprint enables more efficient use of cache memory and reduces memory access latency. In practical deployments, these compressed models can achieve 2-3× speedups for inference tasks, making real-time applications more responsive and reducing operational costs in production environments.

Additionally, the gradient-aware compression techniques here described have been experimentally observed to retain more of the original models' fine-tuning ability than gradient-insensitive alternatives. That is, the gain in accuracy that models compressed with gradient-aware techniques experience by being subjected to fine-tuning after compression is higher than that observed for the same models compressed with non-gradient methods. This suggests that the loss landscape of the models compressed with gradient-aware methods is smoother than that obtained from their alternative, making post-compression fine-tuning more capable of recouping the accuracy lost by the reduction in parameter count.

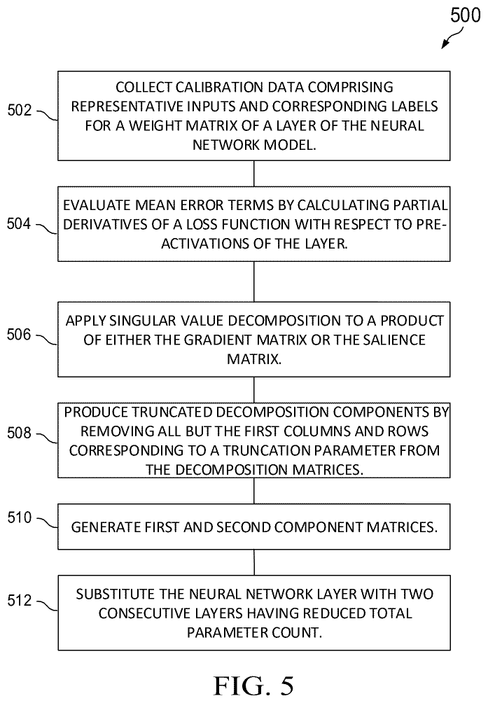

FIG. 5 illustrates a flowchart of an implementation method 500 for gradient-aware compression of a neural network model. In various implementations, the method may include additional or fewer steps, or the steps may be performed differently than illustrated.

At step 502, calibration data comprising representative inputs and corresponding labels for a weight matrix of a layer of the neural network model are collected. If any convolutional layers exist, they are replaced with dense flattened equivalents to facilitate the compression process.

At step 504, the method evaluates mean error terms by calculating partial derivatives of a loss function with respect to pre-activations of the layer. This can be accomplished by performing backpropagation on the neural network model using the calibration data without updating weights. For every layer i and every neuron j of layer i, the error term

$${δ}_{j}^{( i )} = \frac{dL}{{dZ}_{i , j}}$$

is calculated, representing the sensitivity of the model's loss function to changes in each neuron's pre-activation value.

Simultaneously, Cholesky decomposition is performed on an input XX^{T}, where X is the matrix of input activations to the layer being compressed, leading to the equivalence XX^{T}=SS^{T}, where S is a lower-triangular matrix that shall later be used as scaling matrix in the compression process.

Cholesky decomposition requires its input matrix to be positive-definite. Since XX^{T} is only guaranteed to be positive semi-definite, it suffices to add any small positive multiple of the identity matrix to XX^{T}, prior to its Cholesky processing, to ensure its positive definiteness. The scalar ϵ₁ multiplying the identity matrix is typically in the range between 10⁻¹⁰ to 10⁻⁵. Higher values achieve higher numerical stability at the cost of losing sensitivity to the original X.

In an alternative implementation, the method sorts the partial derivatives in descending order to produce a sequence of gradient values. A power factor greater than one and not lower than three is selected to determine a threshold for neuron importance during compression.

The method then evaluates a maximum integer that satisfies an inequality wherein a sum of partial derivatives for a subset of neurons is greater than the product of the power factor, a ratio representing the subset size relative to a total number of neurons, and a sum of all partial derivatives.

Based on this evaluation, a set of salient neurons is defined. A sequence is created where each element corresponds to a neuron, with elements corresponding to salient neurons having a value of two and elements corresponding to non-salient neurons having a value of one.

A salience matrix is defined as a diagonal matrix based on this sequence while preserving original neuron indexing. In this implementation, the salience matrix is used in place of the gradient matrix in subsequent steps.

At step 506, singular value decomposition is applied to a product of either the gradient matrix or the salience matrix (depending on implementation), the weight matrix, and the scaling matrix. This results in a decomposition comprising a first orthogonal matrix, a diagonal matrix of singular values, and a second orthogonal matrix. A target singular loss tolerance is selected to constrain information loss during the compression process.

At step 508, the method produces truncated decomposition components by removing all but the first columns and rows corresponding to a truncation parameter from the decomposition matrices. The truncation parameter is determined as the largest integer that maximizes a sum of squared singular values subject to a constraint that the sum of squared discarded singular values does not exceed the target singular loss tolerance multiplied by the sum of all squared singular values.

At step 510, a first component matrix is generated by multiplying the inverse of either the gradient matrix or the salience matrix by the truncated first orthogonal matrix and the truncated diagonal matrix of singular values. Concurrently, a second component matrix is generated by multiplying the truncated second orthogonal matrix by the inverse of the scaling matrix.

At step 512, the layer in the neural network model is substituted with two consecutive layers having reduced total parameter count. The first consecutive layer has weights corresponding to the first component matrix, and the second consecutive layer has weights corresponding to the second component matrix. This substitution significantly reduces the memory requirements of the model while preserving its functional characteristics in directions that most significantly impact the loss function.

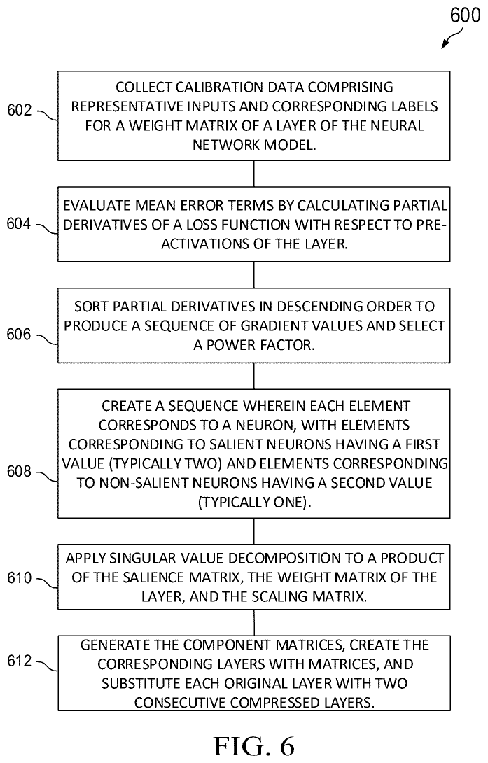

FIG. 6 illustrates a flowchart of an implementation method 600 for neural network compression using a power factor approach. In various implementations, the method may include additional or fewer steps, or the steps may be performed differently than illustrated.

At step 602, calibration data for a neural network model with multiple layers is collected. This calibration data provides representative inputs and corresponding labels that will be used to evaluate the importance of different neurons to the model's performance.

At step 604, the method evaluates error terms by calculating partial derivatives of a loss function with respect to pre-activations of each layer. This can be accomplished by performing backpropagation on the neural network model using the calibration data without updating weights. These partial derivatives represent the sensitivity of the model's loss function to changes in each neuron's pre-activation value.

At step 606, for each layer, the method sorts the partial derivatives in descending order to produce a sequence of gradient values and selects a power factor greater than one, typically not lower than three.

The method then defines a set of salient neurons. In a first approach, the method evaluates a maximum integer that satisfies an inequality wherein a sum of partial derivatives for a subset of neurons is greater than the product of the power factor, a ratio representing the subset size relative to a total number of neurons, and a sum of all partial derivatives.

In the alternative approach, the method selects all neurons having absolute partial derivative values more than a predetermined number of standard deviations higher than the mean of the distribution of absolute partial derivative values.

At step 608, for each layer, the method creates a sequence wherein each element corresponds to a neuron, with elements corresponding to salient neurons having a first value (typically two) and elements corresponding to non-salient neurons having a second value (typically one). A salience matrix is then defined as a diagonal matrix based on this sequence. Simultaneously, Cholesky decomposition is performed on a Gram matrix XX^{T} built from input activations X to generate a scaling matrix.

At step 610, singular value decomposition is applied to a product of the salience matrix, the weight matrix of the layer, and the scaling matrix. This results in a decomposition comprising a first orthogonal matrix, a diagonal matrix of singular values, and a second orthogonal matrix.

A truncation parameter is selected, typically by selecting a target singular loss tolerance and determining the truncation parameter as the largest integer that maximizes a sum of squared singular values subject to a constraint that the sum of squared discarded singular values does not exceed the target singular loss tolerance multiplied by the sum of all squared singular values.

At step 612, the method produces truncated decomposition components by removing columns and rows from the decomposition matrices based on the truncation parameter. A first component matrix is generated by multiplying the inverse of the salience matrix by the truncated first orthogonal matrix and the truncated diagonal matrix of singular values. A second component matrix is generated by multiplying the truncated second orthogonal matrix by the inverse of the scaling matrix.

Finally, each layer in the neural network model is substituted with two consecutive layers, wherein the first consecutive layer has weights corresponding to the first component matrix and the second consecutive layer has weights corresponding to the second component matrix. This power factor approach provides better stability than direct gradient methods when compressing models at higher ratios, as it focuses on preserving the relative importance of neurons rather than their absolute gradient values.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Where appropriate, any suitable operation or sequence described or illustrated herein may be interrupted, suspended, or otherwise controlled by another process, such as an operating system or kernel. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. Therefore, the appended claims are intended to encompass any such modifications or implementations.

What is claimed is:

1. A computer-implemented method for gradient-aware compression of a neural network model, comprising:
collecting calibration data comprising representative inputs and corresponding labels for a weight matrix of a layer of the neural network model;
evaluating mean error terms by calculating partial derivatives of a loss function with respect to pre-activations of the layer by performing backpropagation on the neural network model using the calibration data without updating weights;
generating a diagonal gradient matrix;
performing decomposition on a Gram matrix built from input activations to generate a scaling matrix;
applying singular value decomposition to a product of the gradient matrix, the weight matrix, and the scaling matrix to obtain a decomposition comprising a first orthogonal matrix, a diagonal matrix of singular values, and a second orthogonal matrix;
selecting a target singular loss tolerance that constrains information loss;
producing truncated decomposition components by removing all but the first columns, rows, or columns and rows corresponding to a truncation parameter from the decomposition matrices;
generating a first component matrix by multiplying the inverse of the gradient matrix by the truncated first orthogonal matrix and the truncated diagonal matrix of singular values;
generating a second component matrix by multiplying the truncated second orthogonal matrix by the inverse of the scaling matrix; and
substituting the layer in the neural network model with two consecutive layers having reduced total parameter count.

2. The computer-implemented method of claim 1, further comprising:
sorting, for each layer, the partial derivatives in descending order to produce a sequence of gradient values;
selecting a power factor greater than one and not lower than three, the power factor determining a threshold for neuron importance during compression;
evaluating, for each layer, a maximum integer that satisfies an inequality wherein a sum of partial derivatives for a subset of neurons is greater than the product of the power factor, a ratio representing the subset size relative to a total number of neurons, and a sum of all partial derivatives;
defining a set of salient neurons based on the evaluated maximum integer;
creating, for each layer, a sequence wherein each element corresponds to a neuron, with elements corresponding to salient neurons having a value of two and elements corresponding to non-salient neurons having a value of one; and
defining, for each layer, a salience matrix as a diagonal matrix based on the sequence while preserving original neuron indexing,
wherein applying singular value decomposition uses a product of the salience matrix, the weight matrix, and the scaling matrix, and
wherein the gradient matrix for generating the first component matrix corresponds to the salience matrix.

3. The computer-implemented method of claim 1, further comprising replacing zero values in the diagonal of the gradient matrix with a hyperparameter value between 10⁻¹⁰ and 10⁻⁵, defined by hyperparameter search.

4. The computer-implemented method of claim 1, wherein the decomposition is a Cholesky decomposition.

5. The computer-implemented method of claim 1, wherein determining the truncation parameter comprises determining the truncation parameter as the largest integer that maximizes a sum of squared singular values subject to a constraint that the sum of squared discarded singular values does not exceed the target singular loss tolerance multiplied by the sum of all squared singular values.

6. The computer-implemented method of claim 1, wherein each diagonal element of the diagonal gradient matrix corresponds to a respective partial derivative of the loss function with respect to a corresponding pre-activation of the layer.

7. The computer-implemented method of claim 1, wherein the first consecutive layer has weights corresponding to the first component matrix and the second consecutive layer has weights corresponding to the second component matrix.

8. A computer system for gradient-aware compression of a neural network model, comprising:
a non-transitory memory storage comprising instructions; and
a processor in communication with the non-transitory memory storage, when executed by the processor, cause the processor to:
collect calibration data comprising representative inputs and corresponding labels for a weight matrix of a layer of the neural network model,
evaluate mean error terms by calculating partial derivatives of a loss function with respect to pre-activations of the layer by performing backpropagation on the neural network model using the calibration data without updating weights,
generate a diagonal gradient matrix,
perform decomposition on a Gram matrix built from input activations to generate a scaling matrix,
apply singular value decomposition to a product of the gradient matrix, the weight matrix, and the scaling matrix to obtain a decomposition comprising a first orthogonal matrix, a diagonal matrix of singular values, and a second orthogonal matrix,
select a target singular loss tolerance that constrains information loss,
produce truncated decomposition components by removing all but the first columns, rows, or columns and rows corresponding to a truncation parameter from the decomposition matrices,
generate a first component matrix by multiplying the inverse of the gradient matrix by the truncated first orthogonal matrix and the truncated diagonal matrix of singular values,
generate a second component matrix by multiplying the truncated second orthogonal matrix by the inverse of the scaling matrix, and
substitute the layer in the neural network model with two consecutive layers having reduced total parameter count.

9. The computer system of claim 8, wherein the instructions further cause the processor to:
sort, for each layer, the partial derivatives in descending order to produce a sequence of gradient values;
select a power factor greater than one and not lower than three, the power factor determining a threshold for neuron importance during compression;
evaluate, for each layer, a maximum integer that satisfies an inequality wherein a sum of partial derivatives for a subset of neurons is greater than the product of the power factor, a ratio representing the subset size relative to a total number of neurons, and a sum of all partial derivatives;
define a set of salient neurons based on the evaluated maximum integer;
create, for each layer, a sequence wherein each element corresponds to a neuron, with elements corresponding to salient neurons having a value of two and elements corresponding to non-salient neurons having a value of one; and
define, for each layer, a salience matrix as a diagonal matrix based on the sequence while preserving original neuron indexing,
wherein applying singular value decomposition uses a product of the salience matrix, the weight matrix, and the scaling matrix, and
wherein the gradient matrix for generating the first component matrix corresponds to the salience matrix.

10. The computer system of claim 8, wherein the instructions further cause the processor to replace zero values in the diagonal of the gradient matrix with values between 10⁻¹⁰ and 10⁻⁵, defined by hyperparameter search.

11. The computer system of claim 8, wherein the decomposition is a Cholesky decomposition.

12. The computer system of claim 8, wherein determining the truncation parameter comprises determining the truncation parameter as the largest integer that maximizes a sum of squared singular values subject to a constraint that the sum of squared discarded singular values does not exceed the target singular loss tolerance multiplied by the sum of all squared singular values.

13. The computer system of claim 8, wherein each diagonal element of the diagonal gradient matrix corresponds to a respective partial derivative of the loss function with respect to a corresponding pre-activation of the layer.

14. The computer system of claim 8, wherein the first consecutive layer has weights corresponding to the first component matrix and the second consecutive layer has weights corresponding to the second component matrix.

15. A computer-implemented method for neural network compression using a power factor approach, comprising:
collecting calibration data for a neural network model with multiple layers;
evaluating error terms by calculating partial derivatives of a loss function with respect to pre-activations of each layer by performing backpropagation using the calibration data without updating weights;
sorting, for each layer, the partial derivatives in descending order to produce a sequence of gradient values;
selecting, for each layer, a power factor greater than one;
defining, for each layer, a set of salient neurons;
creating, for each layer, a sequence wherein each element corresponds to a neuron, with elements corresponding to salient neurons having a first value and elements corresponding to non-salient neurons having a second value;
defining a salience matrix as a diagonal matrix based on the sequence;
performing decomposition on a Gram matrix built from input activations to generate a scaling matrix;
applying singular value decomposition to a product of the salience matrix, a weight matrix of the layer, and the scaling matrix to obtain a decomposition comprising a first orthogonal matrix, a diagonal matrix of singular values, and a second orthogonal matrix;
selecting a truncation parameter;
producing truncated decomposition components by removing columns, rows, or columns and rows from the decomposition matrices based on the truncation parameter;
generating a first component matrix by multiplying the inverse of the salience matrix by the truncated first orthogonal matrix and the truncated diagonal matrix of singular values;
generating a second component matrix by multiplying the truncated second orthogonal matrix by the inverse of the scaling matrix; and
substituting the layer with two consecutive layers, wherein the first consecutive layer has weights corresponding to the first component matrix and the second consecutive layer has weights corresponding to the second component matrix.

16. The computer-implemented method of claim 15, wherein defining the set of salient neurons comprises:
evaluating, for each layer, a maximum integer that satisfies an inequality wherein a sum of partial derivatives for a subset of neurons is greater than the product of the power factor, a ratio representing the subset size relative to a total number of neurons, and a sum of all partial derivatives; and
defining, for each layer, a set of salient neurons based on the evaluated maximum integer.

17. The computer-implemented method of claim 15, wherein defining the set of salient neurons comprises:
selecting all neurons having absolute partial derivative values more than a predetermined number of standard deviations higher than a mean of a distribution of absolute partial derivative values; and
defining, for each layer, a set of salient neurons based on the evaluated maximum integer.

18. The computer-implemented method of claim 15, wherein the first value is two and the second value is one.

19. The computer-implemented method of claim 15, wherein the decomposition is a Cholesky decomposition.

20. The computer-implemented method of claim 15, wherein selecting the truncation parameter comprises:
selecting a target singular loss tolerance; and
determining the truncation parameter as the largest integer that maximizes a sum of squared singular values subject to a constraint that the sum of squared discarded singular values does not exceed the target singular loss tolerance multiplied by the sum of all squared singular values.
